(19) United States
(12) Patent Application Publication
(10) Pub. No.: US 2018/0280780 A1
(43) Pub. Date: Oct. 4, 2018

(54) FLYING DEVICE, MOVING DEVICE, SERVER AND PROGRAM

(71) Applicant: NIKON CORPORATION, Tokyo (JP)

(72) Inventors: Yuji NAKAO, Kawasaki-shi (JP); Akinobu SUGA, Tokyo (JP); Hironori KOBAYASHI, Kawasaki-shi (JP); Teruo KOBAYASHI, Yokohama-shi (JP)

(73) Assignee: NIKON CORPORATION, Tokyo (JP)

(21) Appl. No.: 15/765,237

(22) PCT Filed: Sep. 21, 2016
(86) PCT No.: PCT/JP2016/077907

§ 371 Date: Mar. 30, 2018

(30) Foreign Application Priority Data
Sep. 30, 2015 (JP) 2015-195278

(51) Int. Cl. A63B 71/06; B64C 39/02; G06K 9/00

(52) U.S. Cl. CPC A63B 71/06; B64C 39/024; B64C 2201/145; B64C 2201/127; B64C 2201/024; G06K 9/00664

(57) ABSTRACT

A flying device includes: an image capturing unit that captures an image of an object that is moving; a flying unit that flies with the image capturing unit mounted thereat; and a control unit that controls at least one of the flying unit and the image capturing unit with control information based on an output from the image capturing unit so as to engage the image capturing unit, after having captured the image of the object, to capture an image of the object.

### TECHNICAL FIELD

The present invention relates to a flying device, a moving device, a server and a program.

### BACKGROUND ART

Unmanned aerial vehicles mounted with cameras are known in the related art (see, for instance, PTL1). The unmanned aerial vehicle in PTL1, which may be a helicopter, a quadricopter (four-rotor helicopter) or the like, having rotor blades, is mounted with a front camera that captures an image of the scene ahead of the unmanned aerial vehicle and a vertically-oriented camera that captures an image of the terrain below the unmanned aerial vehicle. However, the publication does not include any mention of a structure that will enable the unmanned aerial vehicle to provide assistance to a player engaged in a sporting game.

### CITATION LIST

### Patent Literature

PTL1: Japanese Laid Open Patent Publication No. 2012-6587

### SUMMARY OF INVENTION

According to the 1st aspect of the present invention, a flying device comprises: an image capturing unit that captures an image of an object that is moving; a flying unit that flies with the image capturing unit mounted thereat; and a control unit that controls at least one of the flying unit and the image capturing unit with control information based on an output from the image capturing unit so as to engage the image capturing unit, after having captured the image of the object, to capture an image of the object.

According to the 2nd aspect of the present invention, it is preferable that in the flying device according to the 1st aspect, the control unit controls the flying unit so that the flying unit flies to a position at which the image capturing unit, having captured the image of the object, is able to capture an image of the object.

According to the 3rd aspect of the present invention, it is preferable that in the flying device according to the 1st or 2nd aspect, the image capturing unit captures images of the object that is moving with varying timing.

According to the 4th aspect of the present invention, it is preferable that in the flying device according to any one of the 1st through 3rd aspects, the control unit controls the image capturing unit so as to adjust an angle of view for capturing the image.

According to the 5th aspect of the present invention, it is preferable that in the flying device according to any one of the 1st through 4th aspects, the control unit engages the image capturing unit, having captured the image of the object, in operation to capture the image of the object.

According to the 6th aspect of the present invention, it is preferable that in the flying device according to any one of the 1st through 5th aspects, the control information includes information based on movement of the object.

According to the 7th aspect of the present invention, it is preferable that in the flying device according to any one of the 1st through 6th aspects, the control information includes information related to a position at which the object that is moving comes to a stop.

According to the 8th aspect of the present invention, it is preferable that in the flying device according to the 7th aspect, the control information includes information related to a position at which the object is predicted to stop based on an output from the image capturing unit having captured the image of the object that was moving.

According to the 9th aspect of the present invention, it is preferable that in the flying device according to any one of the 1st through 8th aspects, the control unit controls the flying unit so that the flying unit flies based on a position at which the object that was moving has stopped moving.

According to the 10th aspect of the present invention, it is preferable that in the flying device according to any one of the 1st through 9th aspects, the control unit controls the flying unit so that the flying unit flies to a position at which the object that was moving has stopped moving.

According to the 11th aspect of the present invention, it is preferable that in the flying device according to the 10th aspect, the control unit controls the flying unit so that the flying unit flies above the position at which the object that was moving has stopped moving.

According to the 12th aspect of the present invention, the flying device according to any one of the 1st through 11th aspect may further comprise: a transmission unit that transmits, to another electronic device, information related to the object having stopped moving.

According to the 13th aspect of the present invention, it is preferable that in the flying device according to the 12th aspect, the image capturing unit captures the image of at least one of the object having stopped and a position at which the object, having stopped, is present.

According to the 14th aspect of the present invention, it is preferable that in the flying device according to the 13th aspect, the transmission unit transmits, to the other electronic device, image data obtained by capturing the image of at least one of the object having stopped and the position at which the object, having stopped, is present.

According to the 15th aspect of the present invention, it is preferable that in the flying device according to any one of the 1st through 14th aspect, the image capturing unit captures the image of the object from a position above the object before the object starts moving.

According to the 16th aspect of the present invention, it is preferable that in the flying device according to the 15th aspect, the image capturing unit captures the image of the object that is moving so that movement of the object that is moving along a horizontal direction can be tracked.

According to the 17th aspect of the present invention, it is preferable that in the flying device according to any one of the 1st through 16th aspects, the control device controls the flying unit based on an environment or a subject.

According to the 18th aspect of the present invention, it is preferable that in the flying device according to the 17th aspect, the control unit controls the flying unit based on a sun position or a position of the subject.

According to the 19th aspect of the present invention, it is preferable that in the flying device according to the 17th or 18th aspect, the subject is a person.

According to the 20th aspect of the present invention, it is preferable that in the flying device according to any one of the 1st through 19th aspects, the image capturing unit captures the image of a first object having stopped moving; and the control unit controls the flying unit so that the flying unit flies, once the image capturing unit has captured the image of the first object, to a point above a second object, different from the first object, which is yet to start moving.

According to the 21st aspect of the present invention, it is preferable that in the flying device according to any one of the 1st through 20th aspects, the object is a ball.

According to the 22nd aspect of the present invention, it is preferable that in the flying device according to any one of the 1st through 21st aspects, the control unit controls the flying unit so that the flying unit flies to a position at which the flying unit does not collide with the object.

According to the 23rd aspect of the present invention, the flying device according to any one of the 1st through 22nd aspects may further comprise: a communication unit that communicates with a server, wherein: the communication unit transmits the output from the image capturing unit to the server and receives, from the server, the control information based on the output from the image capturing unit.

According to the 24th aspect of the present invention, the flying device according to any one of the 1st through 22nd aspects may further comprise: a generation unit that generates the control information based on the output from the image capturing unit.

According to the 25th aspect of the present invention, a server communicating with the flying device according to any of the 1st through 23rd aspects comprises: a reception unit that receives image data from the flying device; a generation unit that generates the control information based on the image data; and a transmission unit that transmits the control information to the flying device.

According to the 26th aspect of the present invention, a program for controlling a flying unit of a flying device that flies with an image capturing unit mounted thereat enables a computer to execute: image capturing processing through which the image capturing unit is engaged in operation to capture an image of an object that is moving; and control processing through which at least one of the flying unit and the image capturing unit is controlled with control information based on an output from the image capturing unit so as to engage the image capturing unit, after having captured the image of the object, to capture an image of the object.

According to the 27th aspect of the present invention, a moving device, comprises: an image capturing unit that captures an image of an object that is moving; a moving unit that moves with the image capturing unit mounted thereat; and a control unit that controls at least one of the moving unit and the image capturing unit with control information based on an output from the image capturing unit so as to engage the image capturing unit, after having captured the image of the object, to capture an image of the object.

According to the 28th aspect of the present invention, a flying device comprises: an acquiring unit that obtains flight information based on information related to a sporting game; a flying unit that flies with the acquiring unit; and a control unit that controls the flying unit based upon the flight information.

According to the 29th aspect of the present invention, it is preferable that in the flying device according to the 28th aspect, the control unit controls the flying unit so that the flying unit flies to a position ahead of a player engaged in the game.

According to the 30th aspect of the present invention, it is preferable that in the flying device according to the 29th aspect, the control unit controls the flying unit so that the flying unit flies to a visible position at which the flying unit can be seen by the player.

According to the 31st aspect of the present invention, it is preferable that in the flying device according to the 30th aspect, the visible position includes a position providing a marker for the player.

According to the 32nd aspect of the present invention, it is preferable that in the flying device according to the 31st aspect, the visible position includes a position providing a marker related to altitude.

According to the 33rd aspect of the present invention, it is preferable that in the flying device according to any one of the 30th through 32nd aspects, the control unit controls the flying unit based on the flight information obtained by the acquiring unit after the flying unit flies to the visible position.

According to the 34th aspect of the present invention, it is preferable that in the flying device according to any one of the 28th through 33rd aspects, the acquiring unit obtains specified position information based on a specified position specified by a player engaged in the game; and the control unit controls the flying unit based on the specified position information.

According to the 35th aspect of the present invention, it is preferable that in the flying device according to any one of the 28th through 34th aspects, the information related to the game includes at least one of; information related to a player engaged in the game, information related to a tool used in the game and information related to an environment in which the game is played.

According to the 36th aspect of the present invention, it is preferable that in the flying device according to the35th aspect, the information related to the player includes at least one of; information related to motion of the player, information related to attributes of the player and information related to a position of the player.

According to the 37th aspect of the present invention, it is preferable that in the flying device according to the 36th aspect, the attributes of the player include at least one of; gender, age and an evaluation value with respect to the player.

According to the 38th aspect of the present invention, it is preferable that in the flying device according to any one of the 35th through 37th aspects, the information related to the tool used in the game includes information on a type of the tool.

According to the 39th aspect of the present invention, it is preferable that in the flying device according to any one of the 35th through 38th, the information related to the environment in which the game is played includes at least either; information on a course where the game is played or wind information.

According to the 40th aspect of the present invention, it is preferable that in the flying device according to any one of the 28th through 39th aspects, the acquiring unit obtains first flight information in relation to a first player engaged in the game and second flight information in relation to a second player, different from the first player; and the control unit first controls the flying unit based on the first flight information and then controls the flying unit based on the second flight information.

According to the 41st aspect of the present invention, the flying device according to any one of the 28th through 40th aspects may further comprise: an image capturing unit that obtains image data, wherein: the acquiring unit obtains the flight information based on the image data.

According to the 42nd aspect of the present invention, it is preferable that in the flying device according to the 41st aspect, the image capturing unit captures an image of an object to which a force is applied by a player engaged in the game; and the acquiring unit obtains the flight information based on a trajectory of the object.

According to the 43rd aspect of the present invention, it is preferable that in the flying device according to the 42nd aspect, the image capturing unit captures an image of the player before the player applies a force to the object.

According to the 44th aspect of the present invention, it is preferable that in the flying device according to the 42nd or 43rd aspect, the image capturing unit captures an image of the object that is moving; and the control unit controls the flying unit so that the flying unit flies to a position at which the flying unit does not collide with the object that is moving.

According to the 45th aspect of the present invention, the flying device according to any one of the 41st through 44th aspects may further comprise: a transmission unit that transmits the image data obtained via the image capturing unit to another electronic device.

According to the 46th aspect of the present invention, it is preferable that in the flying device according to any one of the 28th through 45th aspects, the acquiring unit obtains the flight information from another electronic device.

According to the 47th aspect of the present invention, the flying device according to any one of the 28th through 46th may further comprise: a transmission unit that transmits data related to advice related to the game to a display device.

According to the 48th aspect of the present invention, a server engaged communicating with the flying device according to any one of the 28th through 47th aspects comprises: a generation unit that generates the flight information based on information related to the game; and a transmission unit that transmits the flight information to the flying device.

According to the 49th aspect of the present invention, a program for controlling a flying unit capable of flying enables a computer to execute; acquiring processing through which flight information based on information related to a sporting game is obtained; and control processing through which the flying unit is controlled based on the flight information.

According to the 50th aspect of the present invention, a moving device comprises: an acquiring unit that obtains movement information generated based on information related to a sporting game; a moving unit that moves with the acquiring unit held therein; and a control unit that controls the moving unit based on the movement information.

### BRIEF DESCRIPTION OF THE DRAWINGS

FIG. 1 A block diagram schematically illustrating the configuration of an assistance system

FIG. 2 Schematic illustrations providing external views of a drone

FIG. 3 A flowchart of an assist operation through which a landing position is reported

FIG. 4 Illustrations in reference to which the concept of the predetermined position will be explained

FIG. 5 Examples of flight paths that the drone may take

FIG. 6 A schematic illustration presenting examples of positions that may be assumed by the drone so as to provide aiming direction advice

FIG. 7 A flowchart of advice processing that may be executed

FIG. 8 A flowchart of an assist operation executed to recommend a golf club choice

FIG. 9 An illustration of a gripping device

FIG. 10 A diagram of the configuration of an assistance system comprising a drone, a portable terminal and a communication network

FIG. 11 Another example of a configuration that may be adopted in an assistance system comprising a drone, a portable terminal, a server and a communication network

FIG. 12 An illustration of a display image brought up on display at the portable terminal

FIG. 13 Illustrations related to a golf cart

FIG. 14 Illustrations presenting another example of the predetermined position

### DESCRIPTION OF EMBODIMENTS

The following is a description of embodiments of the present invention, given in reference to drawings.

### First Embodiment

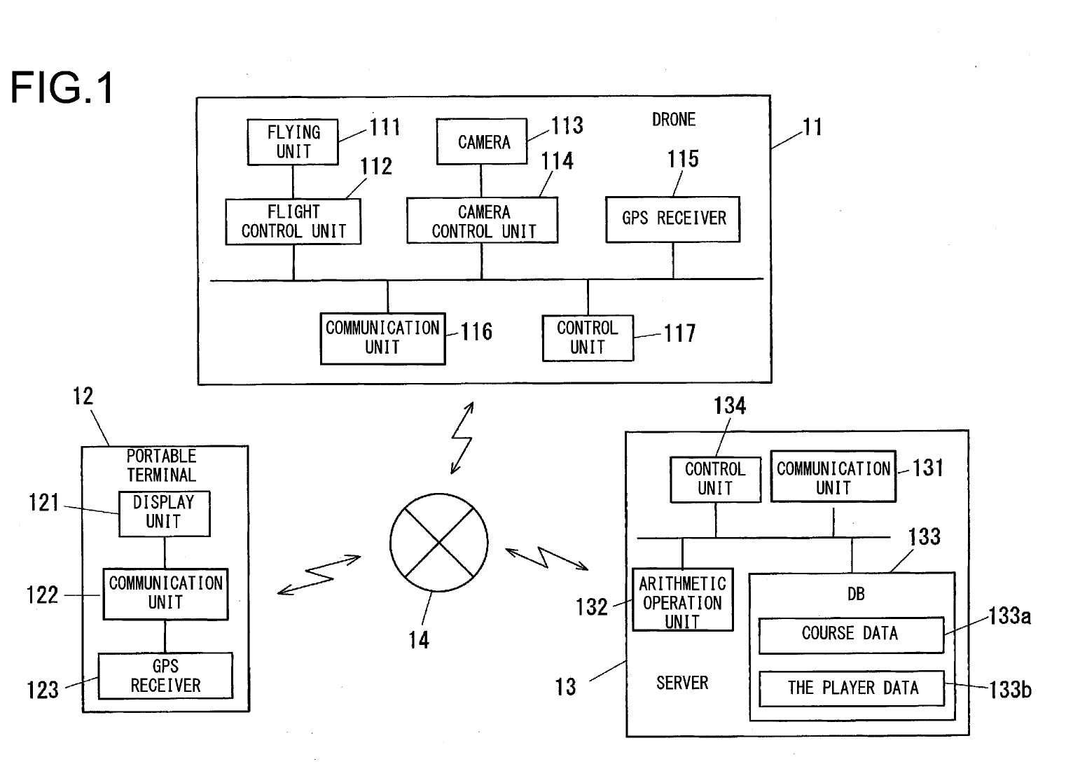

FIG. 1 is a block diagram schematically illustrating the configuration of an assistance system that includes a flying device constituted of an unmanned aerial vehicle (UAV) 11 as an embodiment of the present invention. An assistance system 1 comprises the UAV 11, a portable terminal 12 and a server 13. The UAV 11, the portable terminal 12 and the server 13 are connected to a communication network 14. The UAV 11 is an autonomous unmanned aerial vehicle capable of flying autonomously, which may be, for instance, an autonomous multi-copter often referred to as a drone. In the following description, the UAV 11 will be referred to as the drone 11.

The drone 11 is a multi-copter having a plurality of propellers (rotors). The drone 11 comprises a flying unit 111 having a plurality of rotors, a flight control unit 112 that controls the flying unit 111, a camera 113, a camera control unit 114, a GPS (global positioning system) receiver 115, a communication unit 116, a control unit 117 that executes overall control of the drone 11, and the like.

The flight control unit 112 individually controls the plurality of rotors in the flying unit 111 independently of one another through a navigation attitude control system of the known art. The camera 113, which includes an electronic image sensor such as a CCD image sensor, is capable of capturing still images and movie images. Various types of control, including zooming, autofocus and auto-exposure are enabled in the camera 113. In addition, the camera 113 is mounted on a gimbal (rotary table) and thus, the direction of its visual field relative to the drone main body can be adjusted up/down and left/right. The camera 113 is controlled by the camera control unit 114, and image capturing data transmitted via the communication unit 116 are provided to the portable terminal 12 or the server 13 via the communication network 14.

The GPS receiver 115 receives signals from GPS satellites and detects an absolute position of the drone 11. Information of the absolute position is transmitted from the communication unit 116 to the portable terminal 12 or the server 13. The control unit 117, constituted with a microprocessor and peripheral circuits including a memory (none shown), controls the various parts of the drone 11 by executing a specific control program.

The portable terminal 12 includes a display unit 121, a communication unit 122, a GPS receiver 123 and the like. Data exchange with the drone 11 or the server 13 is enabled via the communication unit 122. The GPS receiver 123 receives signals output from GPS satellites and detects an absolute position of the portable terminal 12. Information of the absolute position (hereafter referred to as GPS position information) is transmitted to the drone 11 or the server 13 from the communication unit 122. Various types of information are displayed at the display unit 121. For instance, course information, a landing position at which the ball has stopped after a shot, a carry distance, advice information and the like are displayed.

The server 13 includes a communication unit 131, an arithmetic operation unit 132, a database 133, a control unit 134 and the like. The communication unit 131 exchanges various types of data with the drone 11 or the portable terminal 12 via the communication network 14. Based upon various types of data received via the communication unit 131, the arithmetic operation unit 132 executes various types of arithmetic operations. For instance, it executes an operation to calculate a flight target position for the drone 11, an operation to analyze an image captured by the camera 113, an operation to generate various types of information to be displayed at the display unit 121 at the portable terminal 12, and the like.

The control unit 134, constituted with a microprocessor and peripheral circuits including a memory (none shown), executes a specific control program. For instance, based on image analysis results provided by the arithmetic operation unit 132, the control unit 134 generates flight command information for the drone 11. The flight command information is transmitted via the communication unit 131 to the drone 11. Data required for assist operations are stored in the database 133. In the example presented in FIG. 1, course data 133a and the player data 133b related to golf assistance are stored. An explanation will be given on an example in which assistance is provided in a game of golf.

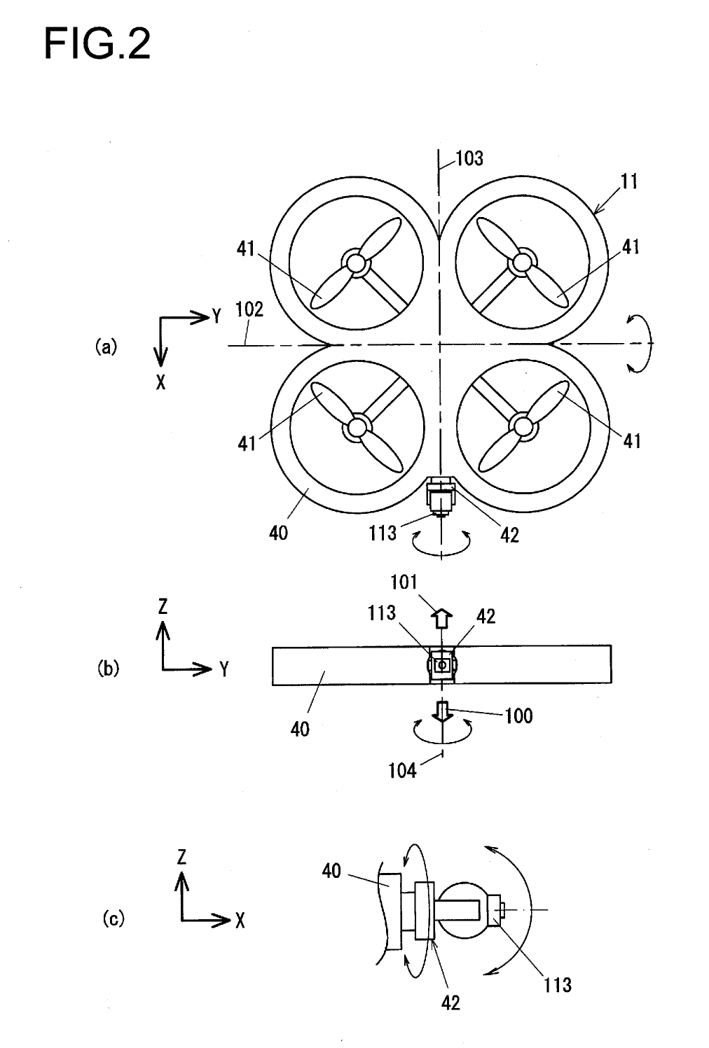

FIG. 2 presents schematic illustrations providing external views of the drone 11. The drone 11 is a multi-copter with four rotors 41. The four rotors 41 are disposed on a single plane. The four rotors 41 are controlled independently of one another via a navigation attitude control system of the known art. Under the control provided through the system, the drone 11 is able to rotate on a pitch axis 102, rotate on a roll axis 103, rotate on a yaw axis 104, translate along a downward direction 100 or along an upward direction 101, and hover at a specific position in the air.

The drone 11 includes a casing 40 disposed around the four rotors 41 for protection. The casing 40 protects the rotors 41 so that they do not come into direct contact with an obstacle along the horizontal flight path. The camera 113 is installed at the bottom surface of the drone 11. The camera 113 is mounted on a gimbal 42 that makes it possible to adjust the attitude of the camera 113 freely.

The assistance system shown in FIG. 1 is used as a golf-play assistant in the embodiment. As the course data 133a, (D1) the hole length and standard number of strokes, (D2) course position information, (D3) recommended clubs (for men and women), (D4) course strategy information and (D5) course layout, for instance, are stored in correspondence to each hole in the database 133.

The course position information is three-dimensional course position information which may include, for instance, tee ground information (latitude/longitude), green position information (latitude/longitude), OB position information (latitude/longitude) and hazard position information. The recommended club information indicates a recommended club for each stroke to achieve par for the hole and the recommended clubs are registered separately for men and for women. The course strategy information indicates the direction along which the golf ball should be hit and the carry distance for each shot to achieve par for the hole, and data are stored in correspondence to various the player levels (evaluation values) including an advanced level, an intermediate level and a beginner level. The course layout information is data expressing a display image to be brought up at, for instance, the display unit 121 at the portable terminal 12, with the tee ground, the green, the bunkers, the OB areas and the like displayed over a two-dimensional image of the entire hole.

In addition, the gender of each player, information indicating the player level (advanced, intermediate, beginner), the denominations of the golf clubs used by the player, the appearance characteristics of the player on the particular day of the game and the like, for instance, are stored as the player data 133b.

It is to be noted that the appearance characteristics of the player are data to be used as a template when making a decision as to whether or not the player is included in an image captured by the camera 113 mounted on the drone 11. For instance, a player image may be photographed in advance on the day of the game and a template created by analyzing the image may be stored. As an alternative, a player image may be captured with the camera 113 on the drone 11 and a template may be created based on the image.

(Description of an Assist Operation)

Next, an assist operation will be described in reference to a specific example. In this example, the player party includes two players, a player A and a player B, and two drones 11 (11a and 11b) are used. The drone 11a provides assistance to the player A and the drone 11b provides assistance to the player B. However, the number of drones 11 used to provide assistance may be one, or three or more. Namely, an optimal number of drones 11 should be set in correspondence to the nature of the assistance to be provided. In addition, the player A carries a portable terminal 12a and the player B carries a portable terminal 12b.

The following is a description of an assist operation executed by the drones 11a and 11b through which landing positions are reported to players A and B. It is to be noted that since identical operations are executed to provide assistance to players A and B, the following explanation will focus on the assistance provided to the player A.

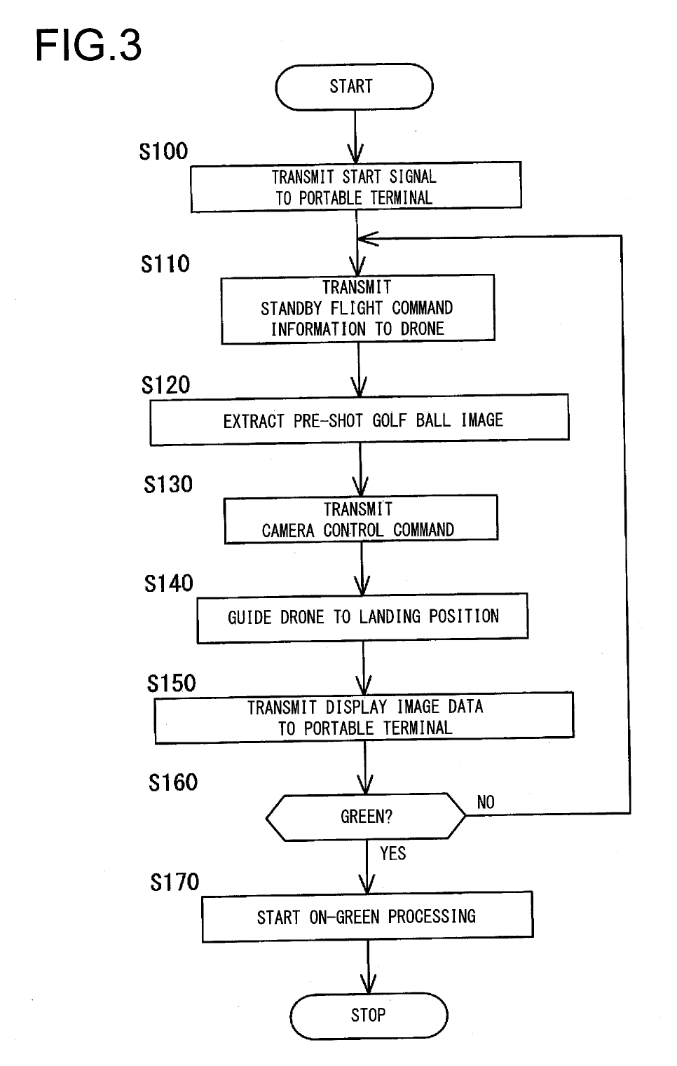

The assist operation for reporting the landing position, the position at which the golf ball struck by the player A has landed is found and the landing position is reported to the player A. An example of a flow of processing that may be executed by the control unit 134 in the server 13 during the assist operation for reporting the landing position to the player A is shown in the flowchart presented in FIG. 3. The landing position is the position at which the golf ball stopped moving.

Upon receiving a start signal from the drone 11a, the control unit 134 starts up. As the player A turns on a power switch (not shown) installed in the drone 11a, power to the drone 11a is turned on and the start signal mentioned above is transmitted from the communication unit 116 in the drone 11a.

In step S100, the control unit 134 transmits a start signal to the portable terminal 12a carried by the player A. Upon receiving the start signal, the portable terminal 12a issues a notice that the drone 11a assisting the player A has started operation. The notice may be provided in a notification mode in which a text message “drone 11a has started operating”, for instance, is brought up on display at the display unit in the portable terminal 12a.

In step S110, the control unit 134 transmits standby flight command information to the drone 11a as a command for the drone 11a to wait in standby at a predetermined position P1. Based upon the standby flight command information transmitted from the server 13, the flight control unit 112 in the drone 11a controls the drone 11a so that it hovers at a predetermined position P1.

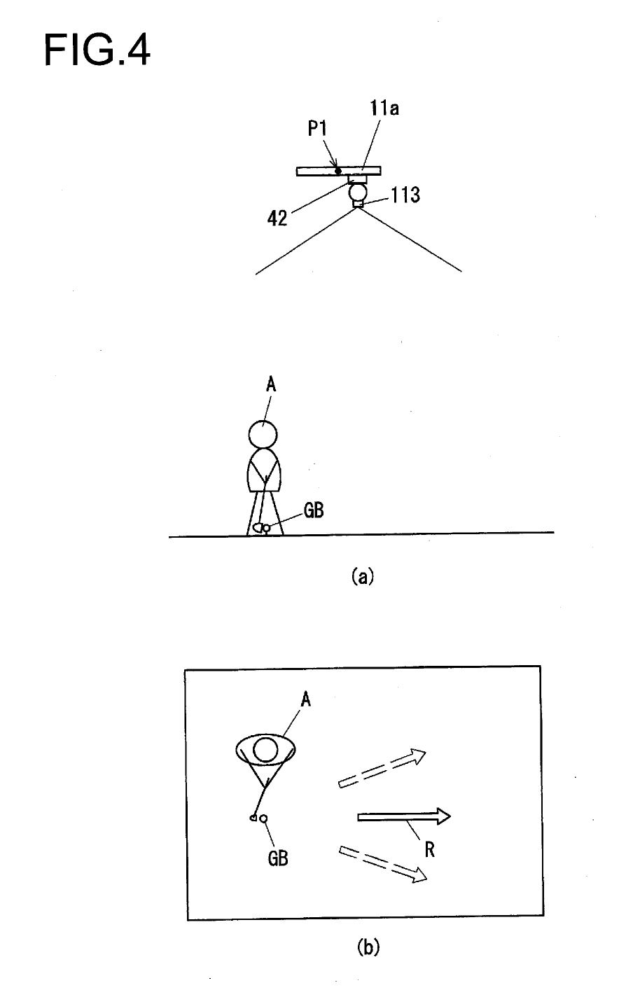

The predetermined position P1 is a position from which an image allowing the direction of a ball struck by the player A to be tracked can be captured. For instance, the predetermined position P1 may be set in the air above the player A or the golf ball GB, as illustrated in FIG. 4(a). From the predetermined position P1, the shooting direction, the player A and the golf ball GB can be contained within the imaging field.

FIG. 4(b) presents an example of an image that may be captured from the predetermined position P1. While an arrow R indicates a recommended shooting direction, the actual shooting direction does not always match the recommended shooting direction R and may be offset to the left or to the right (upward or downward in the figure) relative to the recommended shooting direction, as indicated by the dotted line arrows. For this reason, it is desirable to control the camera 113 so that an image is captured over a range with sufficient margin relative to the recommended shooting direction. By capturing an image from the predetermined position P1 affording a birds-eye view of the player A, as described above, a two-dimensional image of the movement of the golf ball GB can be obtained. The track of the golf ball GB along the horizontal direction can be recognized from the captured image. Since the extent to which the gimbal 42 must be driven when tracking the golf ball GB can be minimized, the landing position of the golf ball GB can be determined with better ease.

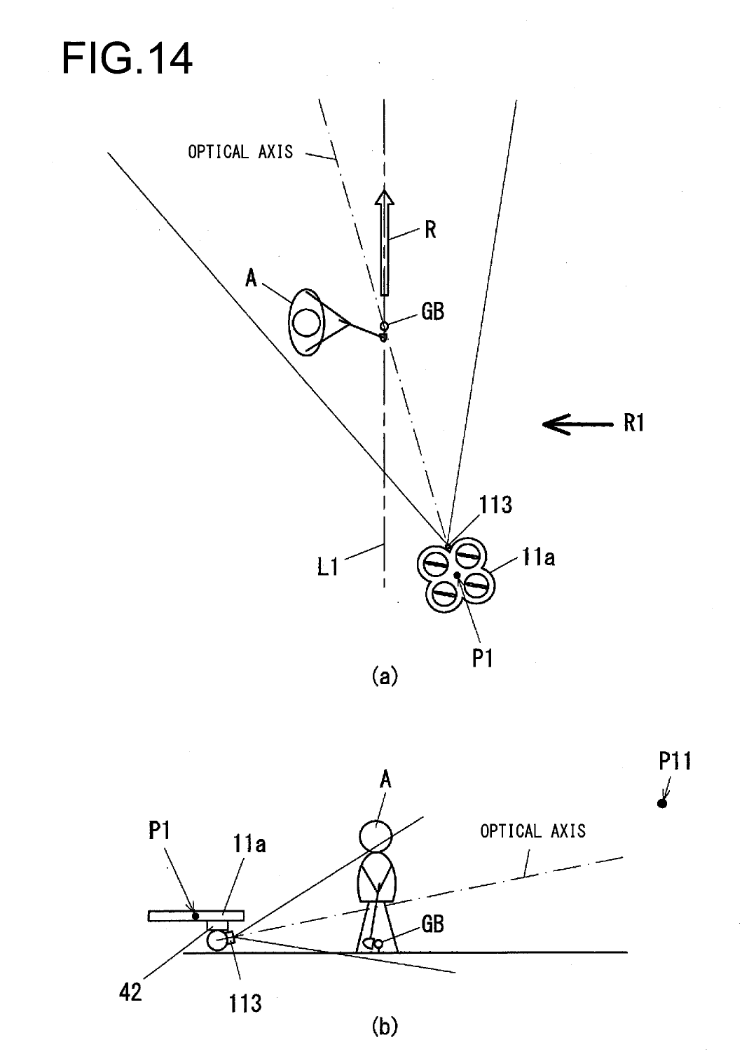

As an alternative, a point close to a line L1 extending along the recommended shooting direction and running by the player A, located to the rear of the player A along a diagonal direction, as shown in FIG. 14, may be selected as the predetermined position P1. FIG. 14(a) is a plan view, whereas FIG. 14(b) provides a view taken from an R1 direction. From this predetermined position P1, the shooting direction, the player A and the golf ball GB can all be contained within the image field.

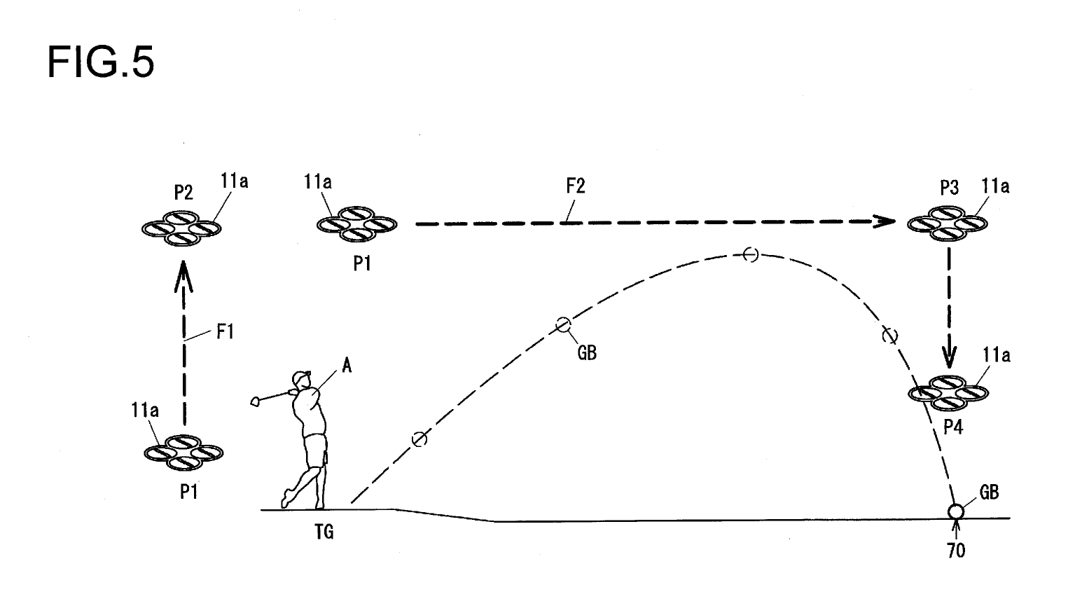

As a further alternative, a position assuming a predetermined altitude above ground level in front of the tee ground, as indicated by reference sign P11 in FIG. 14(b), may be selected as the predetermined position. Furthermore, the direction along which the golf ball is likely to travel and a likely carry distance may be predicted based on the gender and the skill level of the player A, the player conditions on the particular day and the like. In this case, an image of the player A on the tee ground may be captured with the camera 113 from the air above a predicted landing position. To capture such an image, the drone 11a is directed to move in advance to a position in the air (e.g., a position P3 or P4 in FIG. 5 to be explained later) above the predicted landing position.

The predetermined position P1 may be selected based on the GPS position information transmitted from the portable terminal 12a or it may be selected based on an image captured with the camera 113. When selecting the predetermined position P1 based on the GPS position information, the arithmetic operation unit 132 in the server 13 identifies the tee ground where the player A is currently located based on the GPS information provided from the portable terminal 12a and the course position information included in the course data 133a. The standby position for the drone 11a is set at a position P1 achieving a determined altitude relative to the position of the player A having been determined. The altitude of the position P1 is set based on the angle of view of the camera 113 so that the player A, the golf ball GB and shooting direction can all be contained within the image field. The position P1 may be set based on the height of the player A so that danger is caused to the player A.

When setting the predetermined position P1 as a standby position for the drone 11a based on an image, a location should be selected from which an image of the player A and the golf ball GB can be captured based on the position information indicating the location of the player A (the GPS position information provided from the portable terminal 12a), e.g., a position set apart from the player A by a predetermined distance, at which both the player A and the golf ball GB can be set within the angle of view. In this situation, the predetermined position is set by ensuring that no obstacle is present between the player A and the camera 113. In addition, the shooting direction may be predicted based on the positions of the feet of the player A as he strikes the golf ball and the direction along which the optical axis of the camera 113 extends may be determined accordingly in the example presented in FIG. 14.

The server 13 is capable of determining the exact location of the player A, i.e., a specific position at a specific hole, based on the GPS position information provided from the portable terminal 12a carried by the player A and the course data 133a stored in the database 133. For instance, it may ascertain that the player A is currently located on a tee ground and in such a case, it is able to calculate a standby position for the drone 11a, as described below. The shooting direction for the tee shot (first stroke) is stored as the course data 133a in the database 133 in correspondence to each hole. The server 13 calculates the predetermined position P1 based on the shooting direction stored in the course data 133a and transmits the predetermined position P1 calculated as standby flight command information to the drone 11a. In response, the drone 11a waits in standby, hovering at the predetermined position P1.

The data indicating the shooting direction are stored only for the tee shot (first stroke) in the course data 133a. Accordingly, the direction along which a line connecting the golf ball and the pole on the green may be designated as the shooting direction for the second stroke or a subsequent stroke and a predetermined direction P1 for the second stroke or a subsequent stroke may be determined accordingly.

Upon judging, based on image information (movie information), that the golf ball has been teed up and the golf club has been taken up, the control unit 134 extracts an image of the teed-up golf ball in step S120. The server 13 stores this golf ball image as a tracking target template image. If the angle of view of the camera 113 is too wide, the golf ball will appear small and thus will be difficult to track. Accordingly, the camera control unit 114 controls the camera 113 to assume an angle of view at which the size of a golf ball within the imaging field is optimized.

As the golf club is swung, resulting in a change in the position of the golf ball, i.e., as the golf ball moves from a first position to a second position, the camera 113 tracks a subject in captured images that is similar to the template image. The first position and the second position are arbitrary positions assumed by the golf ball after it is struck. The camera 113 tracks the golf ball by capturing images of the golf ball at different time points (e.g., capturing a movie image of the golf ball), extracting the golf ball in the images captured at the different time points and recognizing a change in the position of the golf ball after it has been struck, i.e., the displacement of the golf ball from the first position to the second position. The arithmetic operation unit 132 at the server 13 executes an arithmetic operation based on the image data provided by the drone 11a to determine the direction of the shot and the trajectory of the golf ball (golf ball trajectory), and based on the arithmetic operation results, it executes an arithmetic operation to generate camera control information indicating a gimbal control quantity, a zoom quantity for the camera 113 and the like required to keep the golf ball within the visual field of the camera. In other words, it executes an arithmetic operation to generate camera control information required to keep the golf ball within the visual field of the camera at and beyond the time point at which the golf ball has moved to the second position. Once the golf ball has moved to the second position it may continue to move or it may stop moving. The camera control information obtained through the arithmetic operation is transmitted from the server 13 to the drone 11a. The camera control information includes information needed for adjustment of the angle of view of the camera 113.

Namely, in step S130, the control unit 134 at the server 13 outputs the camera control information and adjusts the image capturing direction (photographing angle, angle of view) and the zoom (angle of view) at the camera 113 so as to ensure that the golf ball (the golf ball having been struck) does not move out of the image field of the camera 113. As an alternative, the flying unit 111 may be controlled so as to enable the drone to travel through the air while photographing the golf ball (the golf ball having been struck) with the camera 113 with the golf ball kept within the image field of the camera 113. Based upon an image captured with the camera 113, the arithmetic operation unit 132 is able to detect the golf ball GB having stopped at a landing position 70.

In step S140, the control unit 134 guides the drone 11a to a position P3 in the air above the landing position 70 at which the golf ball GB stopped (see FIG. 5). FIG. 5 presents an example of a flight path that may be taken by the drone 11a. In FIG. 5, the drone 11a hovers at the predetermined position P1 while the player A addresses the golf ball. Once the player A strikes the golf ball, the golf ball is tracked with the camera 113 based on the camera control information provided by the server 13. As the landing of the golf ball is detected, the control unit 134 in the server 13 controls the drone 11a so that it flies to the position P3 in the air above the landing position 70 at which the shot golf ball GB has come to a stop (indicated with the same reference sign GB as that for the golf ball). If the predetermined position P1 is set behind the player, as shown in FIG. 14, the drone is first directed to fly up to a position P2 from the predetermined position P1 along a flight path F1 and then is directed to travel to the position P3.

The drone 11a may be directed to fly to the ultimate position P3 by, for instance, controlling a flight target position for the drone 11a so as to set the shot golf ball GB in the center of the image while at the same time controlling the gimbal 42 (see FIG. 2 and the like) so that the optical axis of the camera 113 turns gradually downward along the vertical direction. Through this control, the drone 11a is positioned substantially directly above (the position indicated by reference sign P3) of the shot golf ball GB having stopped at the landing position 70 when the optical axis of the camera 113 is set to extend downward along the vertical direction.

Once the drone 11a is positioned substantially directly above (position P3) of the shot golf ball GB, the control unit 134 controls the drone 11a so that it descends to a flight target position P4 at which it can be seen with ease by the player A on the tee ground TG and the drone 11a is then directed to hover at the flight target position P4. The player A on the tee ground visually checking the drone 11a hovering above the course is able to ascertain with ease an approximate distance to the landing position at which the shot golf ball GB has landed. It is to be noted that while an explanation has been given on an example in which control is executed so that the drone 11a is positioned substantially directly above the shot golf ball GB, the present invention is not limited to this example. The drone may instead be controlled to take a position at which the player A is able to ascertain an approximate distance to the landing position at which the shot golf ball GB has landed or a position at which an image of the shot golf ball GB, having stopped, can be captured with the camera 113.

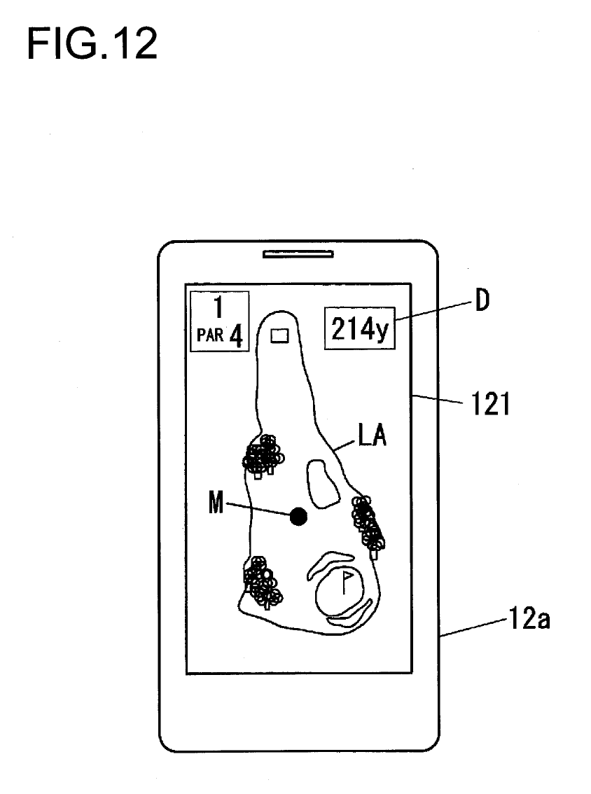

The arithmetic operation unit 132 at the server 13 executes an arithmetic operation based on the GPS position information provided by the drone 11a to determine the latitude and longitude of the landing position 70 and the carry distance. In step S150, the control unit 134 transmits data for a display image to the portable terminal 12a carried by the player A. The display image is displayed on the display unit 121 at the portable terminal 12a. This display image includes a mark M indicating the landing position 70 and a carry distance D, superimposed over a hole layout screen LA stored as the course data 133a in the database 133, as illustrated in FIG. 12. The player A is able to ascertain the landing position at which the shot golf ball GB has stopped with better accuracy by checking the position of the drone 11a hovering above the course and the display image displayed on the portable terminal 12a. The display image may be an image of the shot golf ball GB having come to a stop, captured with the camera 113. The player A is able to grasp the conditions around the landing position where the shot golf ball GB has stopped by viewing such a display image. The landing position conditions may indicate, for instance, that the shot golf ball has landed in tall grass, in an OB area, in water, among trees or the like. When the landing position conditions are such, the stationary shot golf ball GB may be concealed by an obstacle such as a tree, a pond or the like, and thus, the camera 113 may not be able to capture an image of the shot golf ball GB. Even in such a case, an image that indicates the position of the shot golf ball GB having come to a stop can be captured. Namely, the golf ball itself does not need be visible as long as the conditions surrounding the landing position at which the shot golf ball GB has come to a stop can be ascertained.

It is to be noted that the data for the display image may be transmitted to the portable terminal 12b carried by the player B as well as the portable terminal 12a carried by the player A. In addition, once the server 13 receives the GPS position information transmitted from the drone 11a, the display image described above is displayed on the display unit 121 at the portable terminal 12a, and thus, the drone 11a hovering at the flight target position P4 in the air above the landing position may be allowed to travel back toward the player A. For instance, if a single drone 11 is assigned to the entire party, the drone 11 may be utilized as described below. Upon obtaining an image of the shot golf ball GB at the position P3 above the landing position 70, the drone 11 is directed to travel back to the tee ground so as to execute an operational sequence such as that shown in FIG. 5 for the next the player B (for the golf ball struck by the next the player B) as well.

The player B hits his tee shot next. An operation similar to that having been described in relation to the drone 11a assigned to the player A is executed for the drone 11b assigned to the player B. Once the player B hits a tee shot, the player A and the player B move to their respective shot landing positions. The server 13 is able to recognize a move to the shot landing position by the player A based on the GPS position information received from the portable terminal 12a. In addition, since the camera 113 mounted on the drone 11a captures images of the player A, a move by the player A to the shot landing position can also be confirmed based on the images transmitted from the drone 11a as well.

Upon recognizing that the player A has moved toward the landing position 70, the control unit 134 controls the drone 11a so that it too moves toward the landing position 70. In this situation, the drone 11a may be allowed to move toward the landing position 70 without taking into consideration the speed at which the player A is moving toward the landing position 70 or it may be controlled to fly to the landing position 70 so as to guide the player A to the landing position 70.

It is to be noted that if the drone 11a is controlled to remain hovering above the landing position 70, it should sustain the hovering state. In this state, the camera 113 may continue to capture an image of the shot golf ball GB or it may instead capture an image of the player A as he approaches the landing position 70.

In step S160, the control unit 134 makes a decision based on the GPS position information transmitted from the drone 11a having reached the point in the air above the landing position and the course layout information stored as part of the course data 133a in the database 133 as to whether or not the landing position 70 is located on the green. If it is decided in step S160 that the landing position 70 is located on the green (yes) the operation proceeds to step S170 to start on-green processing.

Through the on-green processing, an assist operation for putting is executed since the player will be putting the golf ball on the green. A detailed explanation of the on-green processing will not be included in the description of the embodiment.

Once the processing in step S170 is executed, the processing in the flowchart presented in FIG. 3 ends. If, on the other hand, it is decided in step S160 that the landing position 70 is not on the green (no), the operation returns to step S110 to execute an assist operation for the second stroke, similar to that having been executed for the tee shot (first stroke) described earlier.

By controlling the drone 11a mounted with a camera so as to fly it to the flight target position calculated by analyzing image information as described above, the golf ball landing position can be reported to the player A. As a result, the player is able to play the game smoothly. The use of such a drone 11a makes it possible to eliminate the need for a caddie during a golf game.

(Variation 1 of the First Embodiment)

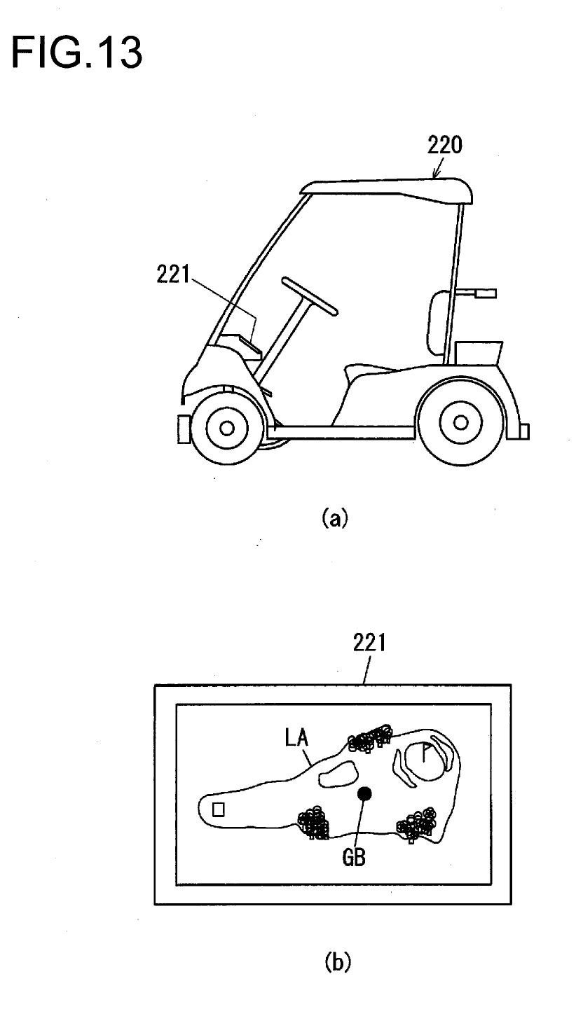

While the landing position at which the golf ball GB has landed is displayed at the display unit 121 at the portable terminal 12 carried by the player, it may instead be displayed at a display device 221 installed in a golf cart (e.g. an electric cart) 220, as illustrated in FIG. 13. FIG. 13(a) is a side view of the cart having the display device 221 installed in front of the driver's seat in the cart 220. FIG. 13(b) presents an example of a display on the display device 221. A mark (a filled circle representing the golf ball GB) which indicates the landing position, is displayed on a hole layout LA displayed on the screen. Since the landing position is displayed at the portable terminal 12 or the like in addition to the drone 11 hovering above to indicate the landing position, the player is able to determine the landing position more accurately.

Furthermore, when the players A and B, each having made his tee shot, move to the respective landing positions, the cart 220 carrying the players A and B may be automatically driven to the landing positions. In such a case, the control unit 134 guides the cart 220 to each landing position based on the GPS position information provided from the drones 11a and 11b hovering above the landing positions.

(Variation 2 of the First Embodiment)

In the embodiment described above, the landing position 70 is reported to the player by displaying a mark representing the landing position 70, superimposed on the course layout screen at the display unit 121 at the portable terminal 12. A zoom-in image of the golf ball may be displayed on the display unit 121 at the portable terminal 12 or at the display device 221 in the cart 220, so as to indicate in detail the course conditions surrounding the landing position 70, as proposed in variation 2. The player is able to ascertain in detail the conditions surrounding the golf ball GB at a landing position 70 in the rough or near a pond, or the inclination of the ground under the golf ball by looking at an image of the golf ball GB at the landing position 70 zoomed in from a side or from diagonally above, and is thus able to make an optimal decision for the next action.

(Variation 3 of the First Embodiment)

It is to be noted that the player may not be able to accurately judge as to which direction he should aim his shot if he has to play from a position where he cannot see the green. Under such circumstances, the drone 11 may be controlled to travel to a position at which an image containing the full range from the lie to the green can be captured and the image thus captured may be displayed on the display unit 121 at the portable terminal 12 or at the display device 221 in the cart 220. Such an assist operation may be executed in response to an instruction issued by the player via the portable terminal 12 or in response to an instruction issued by the server 13.

(Variation 4 of the First Embodiment)

As has been explained in reference to FIG. 5, a single drone 11a is utilized to capture images while the player strikes the golf ball and to report the landing position in the embodiment described above. As an alternative, images may be captured during the shot and the landing position may be reported by engaging separate drones 11a and 11b in coordinated operation. In such a case, one of the drones 11a and 11b may be designated as a master and the other as a slave. For instance, control may be executed by designating the shot making-side drone as a master and a drone tasked to report the landing position as a slave. Furthermore, three or more drones may be engaged in coordinated operation. By engaging a plurality of drones in coordinated operation as described above, the landing position can be located more effectively and accurately.

(Variation 5 of the First Embodiment)

If the landing position is judged to be out of bounds (OB) or judged to have been likely lost during an assist operation executed to report the landing position of the shot golf ball, the player may be prompted to hit a provisional ball via the portable terminal 12 or the display device 21 in the cart 220. The position at which the player should replay the stroke may be indicated on the display unit of portable terminal 12 or the display device 21 in the cart 220. In addition, if it is difficult to determine whether or not the golf ball is OB, the player may be allowed to make a choice. Furthermore, in the case of an OB ball, an image captured during the shot-making (a still image or a movie image) may be appended with an OB tag. The player, viewing the tagged image afterwards is able to adjust his form and the like.

(Variation 6 of the First Embodiment)

While the landing position of the shot golf ball is detected based on image information obtained via the drone 11a in the embodiment described above, the trajectory of the shot golf ball may be determined through an arithmetic operation executed based on image information obtained while the player is making a shot, and the landing position of the shot golf ball may then be estimated based on the arithmetic operation results. In this case, the drone 11a is controlled to fly to a position above the estimated landing position of the shot golf ball, having landed in the area around the estimated landing position, is detected based on an image captured by the camera 113. Once the shot golf ball has been detected, the drone 11a is guided to the position P3 (see FIG. 5) directly above the shot golf ball, as has been explained in reference to the embodiment.

(Variation 7 of the First Embodiment)

While the landing position is detected by tracking the shot golf ball with the camera 113 and the drone 11a is controlled to fly toward the landing position in the embodiment described above, the drone 11a may be engaged in aerial tracking as an alternative. For instance, while the player is making a shot, the drone 11a in FIG. 5 may hover at the predetermined position P1 and once the player A makes a shot, the drone 11a may be engaged in aerial tracking of the shot golf ball through the flight path F2 or through the flight paths F1 and F2, as shown in FIG. 5 based on flight command information provided from the server 13.

If the predetermined position P1 is set to the rear of the player A, the drone 11a should be controlled to ascend to a flight target position P2 through the flight path F1 while continuously capturing images of the shot golf ball GB with the camera 113. By moving the drone upward as described above, it is ensured that the receding shot golf ball GB is contained within the image field of the camera 113 with better ease. Sets of flight command information, each indicating a flight target position determined based on an image captured via the camera 113, are transmitted from the server 13 one at a time. Based upon the sets of flight command information, the drone 11a flies so as to follow the shot golf ball GB through, for instance, the flight path F2 while continuously capturing images of the shot golf ball GB with the camera 113.

(Variation 8 of the First Embodiment)

While the drone 11a is held in standby at the predetermined position P1 in the embodiment described above, the predetermined position P1 may be adjusted in correspondence to the conditions of the particular lie and the drone 11a may wait in standby at the adjusted position (hereafter referred to as a position P12). Factors such as the position of the sun, the denomination of club being used, the player's gender and the player's swing affect the optimal image capturing position. For instance, the golf ball GB viewed from the predetermined position P1 may be back lit and under such circumstances, it will be difficult to see the golf ball GB. Accordingly, the standby position may be adjusted to the position P12 so as to avoid the backlit condition. In addition, if the player is using a driver, the player is male or the swing velocity is high, it will be safe to judge that the carry distance will be great. Accordingly, the drone may wait in standby at the position P12 at which an image can be captured over long range (e.g., a position further upward relative to the predetermined position P1 in FIG. 5).

(Variation 9 of the First Embodiment)

While the player's gender, skill level (advanced, intermediate, beginner) and the like are stored as the player data 133b in the embodiment described above, it is not essential that such the player data 133b be stored. If no player data are available, the player gender and the like may be determined by executing image processing of the known art on image data captured via a camera.

### Second Embodiment

The assistance system in conjunction with a drone 11 in the second embodiment provides various types of advice for the player. Such advice includes advice with regard to the direction in which the golf ball should be advanced, advice on the optimal golf club to be used and advice on shot-making. An explanation will be given on an example in which the assistance system is used in the game of golf.

(2-1. Advice on Shooting Direction)

First, advice provided with regard to the direction along which the golf ball should be played will be explained. Through this assist operation, a target marking the shooting direction is indicated by using the drone 11. An aim-point marker large enough to be recognized visually by the player, to be used as a marker for a target trajectory, is mounted in the drone 11. This marker is normally housed inside the casing of the drone 11 and is let out to the open when an aim-point needs to be indicated. Such a marker may be, for instance, a hanging banner. If such a marker is not housed within the drone, the drone 11 itself may function as a marker. In this case, the drone 11 flies to a position where it can be visually checked by the player and thus can function as a marker for a target trajectory. The arithmetic operation unit 132 in the server 13 executes an arithmetic operation to calculate a target trajectory by referencing the course data 133a and the player data 133b in the database 133 and positions the marker on the target trajectory. The marker for the target trajectory may indicate the direction or may indicate an altitude. In addition, it is desirable for the drone 11 to fly ahead of the player so as to provide a marking for the target trajectory.

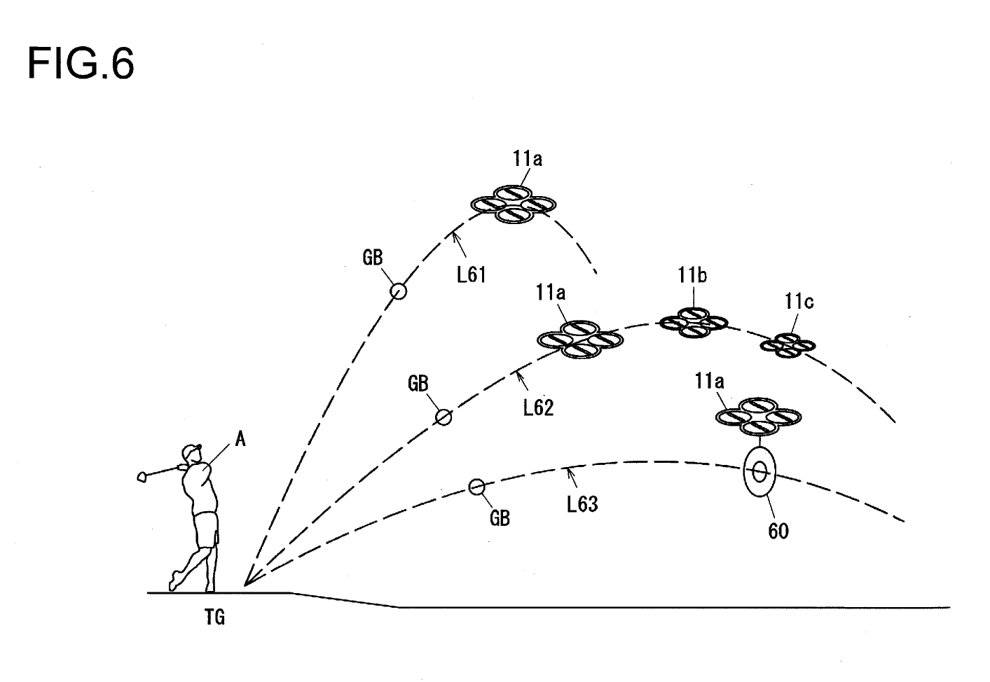

FIG. 6 is a schematic illustration presenting examples of positions that drones may assume when providing advice on the shooting direction. FIG. 6 shows three different target trajectories L61, L62 and L63. A single drone 11a is used as a marker for the target trajectory L61. In this case, the drone 11a is positioned at the apex of the target trajectory L61.

A plurality of drones 11a, 11b and 11c are positioned on the target trajectory L2 so as to allow the player A to visualize a curve representing the target trajectory L62.

For the target trajectory L63, the drone 11a is controlled to hover so that a marker 60 suspended from the drone 11a is positioned on the target trajectory L63. The marker 60 may be positioned at the apex of the trajectory, as is the drone 11a on the target trajectory L61, or it may be positioned at a point other than the apex.

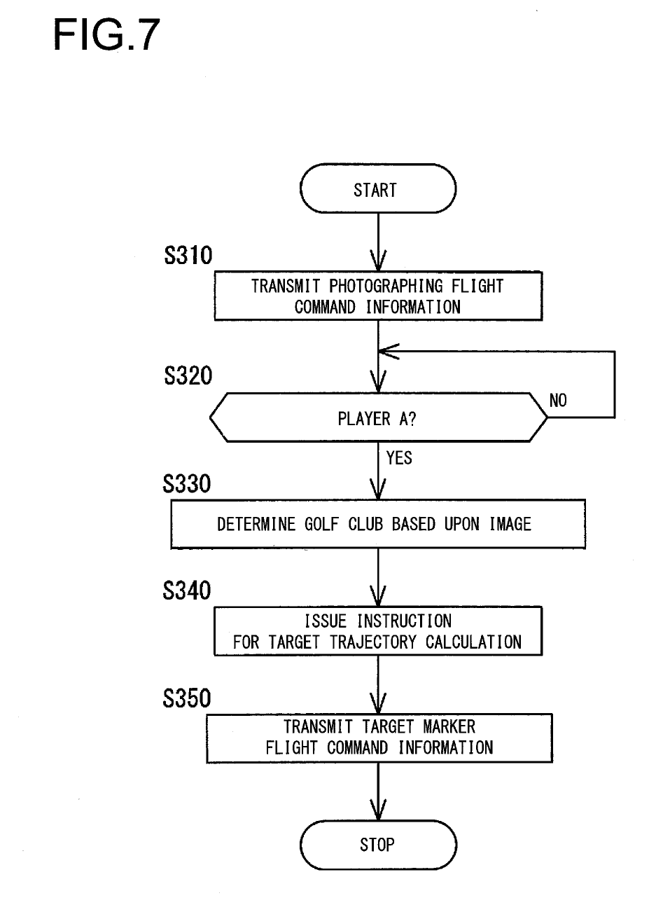

FIG. 7 presents a flowchart of an example of advice processing that may be executed by the control unit 134 in the server 13. In reference to the flowchart, processing executed to provide a marking for the target trajectory L61 as has been explained in reference to FIG. 6 will be described.

In step S310, the control unit 134 transmits photographing flight command information so as to allow the drone 11a to hover at a position (hereafter referred to as a position P20) at which an image of the entire body of the player A can be captured with the camera 113. However, it is not strictly necessary that an image of the entire body of the player A be captured at the position P20, as long as information (captured image) needed to provide advice on the shooting direction and provide various other types of advice to be explained later can be obtained at the position P20. In step S320, the control unit 134 engages the arithmetic operation unit 132 in face recognition based on the image captured via the camera 113 and makes a decision as to whether or not the person in the captured image is the player A. Upon deciding that the person in the image is the player A, the operation proceeds to step S330. Until an image of the player A is captured, the camera 113 continuously executes image capturing operation with the direction of its visual field adjusted up/down and left/right by adjusting the direction along which the optical axis of the camera 113 extends, and the processing in step S320 is repeatedly executed.

In step S330, the control unit 134 makes a decision as to whether or not the golf club held by the player A in the image is one of a plurality of golf clubs registered in the player data 133b in the database 133. In step S340, the control unit 134 engages the arithmetic operation unit 132 in an arithmetic operation to determine a target trajectory based on the results of the decision made in step S330 and the course data 133a and the player data 133b stored in the database 133. In step S350, the control unit 134 transmits marker indication flight command information to the drone 11a so as to move the drone 11a to the position at the apex of the target trajectory L61. The player A then strikes the golf ball GB by aiming toward the hovering drone 11a.

As explained earlier, the hole number, the hole length, par for the hole, the tee ground position information (latitude/longitude), the green position information (latitude/longitude), the recommended club (men and women) for each stroke to achieve par for the hole, advanced player course strategy information, intermediate player course strategy information, beginner player course strategy information, OB location information (latitude/longitude) and the like are stored in the course data 133a. The advanced player course strategy information, the intermediate player course strategy information and the beginner the player course strategy information each include an optimal shooting direction and a standard carry distance registered therein in correspondence to each stroke to achieve par for the hole.

Through the processing executed in step S340, an arithmetic operation is executed to calculate the target trajectory L61 based on the level of the player A (advanced, intermediate or beginner) registered in the player data 133b, the denomination of golf club determined through image recognition, the recommended club for the particular stroke to achieve par for the hole registered in the course data 133a, the course strategy information included in the course data 133a and the like. For instance, the golf club being used by the player A preparing to play his tee shot on the first hole may have been identified as a one iron through image recognition. In this case, if a three wood is registered in the course data 133a as the recommended club for the first hole tee shot, the arithmetic operation is executed by switching to a target trajectory calculation for the one iron, since the trajectory of the golf ball is bound to change in correspondence to the club being used. In addition, since the optimal direction of play and the carry distance will change depending upon the gender of the player A, the arithmetic operation may be executed by taking into consideration these factors as well.

It is to be noted that the target trajectory may be adjusted in correspondence to the conditions of the player A on the particular day. For instance, for a second or subsequent stroke, the conditions of the player A on the day of the game (the player is not getting the expected distance, the player tends to hit to the right, or the like) may be determined based on the previous carry distance and the level of the player A, and the target trajectory should be adjusted in correspondence to the player conditions.

If the player A is struggling and is not be getting his usual carry distance, for instance, an adjustment may be made so as to set a target trajectory that can be achieved by the player on the particular day, which may be shorter than his usual distance. An opposite approach may be taken by adjusting for a target trajectory slightly longer than the distance that can be achieved by the player A on the particular day so as to challenge the player A to improve his game. In addition, if the shot tends to drift to the right, the direction of the target trajectory may be shifted to the left. Furthermore, if the target trajectory calculated through the arithmetic operation does not match the intention of the player A, the player A may specify a position to which he wants the drone 11 to fly via the portable terminal 12. Or a flight destination position for the drone 11 may be specified by the player A in the first place. Under such circumstances, the player A specifies a position to which the drone 11 is to fly via the portable terminal 12. The portable terminal 12 then transmits specified position information indicating the position specified by the player A to the drone 11. Based upon the specified position information having been received, the drone 11 flies to the position specified by the player A. It is to be noted that the portable terminal 12 may instead transmit the specified position information to the server 13, the server 13 then may transmit the specified position information which it has received to the drone 11 and the drone 11 may thereby receive the specified position information.

In addition, while the golf club is identified and a target trajectory is calculated accordingly, the present invention is not limited to this example. If a golf club cannot be identified, a target trajectory may be calculated through an arithmetic operation executed by assuming that the recommended club is being used.

A target trajectory may be calculated through an arithmetic operation executed based on the motion of the player A. In this case, an image of the swing of the player A is captured with the camera 113 and a target trajectory is calculated based on the swing velocity, the angular speed and the like of the swing. For instance, if the swing velocity is high, the golf ball may travel too far, and an adjustment may be made so as to set a shorter target trajectory.

A target trajectory may be calculated through an arithmetic operation executed based on attributes of the player A. For instance, the carry distance of the golf ball is bound to vary depending upon whether the player A is male or female and accordingly, an adjustment may be made for the target trajectory in correspondence to the player's gender.

In addition, the carry distance is bound to vary depending upon the age of the player A, the level of the player A (beginner, intermediate, advanced), the golf club being used and an adjustment should be made for the target trajectory based on these attributes.

A target trajectory may be calculated through an arithmetic operation executed based on the number of strokes to achieve par. In this case, a target trajectory from the current position of the player A, which will allow the player A to hole out at par or better, is calculated. For instance, for a par three hole, the player may not have achieved the standard carry distance for the first stroke (the distance achieved by the player with his first stroke is less than the standard distance) and in such a case, the player will need to achieve a distance greater than the standard carry distance for the second stroke.

Accordingly, the drone 11 will indicate a target trajectory for a distance greater than the standard carry distance for the second stroke. Since the drone 11 provides a marker for a distance greater than the standard carry distance, the player A is able to recognize the need for greater distance. Therefore, he may decide to switch to another club.

While a target trajectory is calculated through an arithmetic operation executed based on personal details related to the player A or the golf club being used, the present invention is not limited to these examples. For instance, a target trajectory may be calculated through an arithmetic operation executed based on atmospheric condition information (wind velocity, wind direction and the like). For instance, if wind is blowing hard from left to right, the golf ball will tend to drift to the right. Under these conditions, an arithmetic operation should be executed to calculate a target trajectory offset to the left relative to the standard target position.

A target trajectory may be calculated through an arithmetic operation executed based on the orientation of the body of the player A. The direction along which the golf ball flies changes in correspondence to the orientation of the body of the player A. Accordingly, if the body of the player A is judged to be oriented to the right, an arithmetic operation may be executed so as to offset the target trajectory to the left.

As described above, a target trajectory is calculated through an arithmetic operation executed based on information related to a specific sporting game (golf) and the flight of the drone 11 is controlled accordingly. The information related to the particular sporting game (golf) may be obtained through images captured with the camera 113 or from data such as the course data 133a and the player data 133b stored in the server or the like. Once the player A makes a shot, a target trajectory is calculated for the next player, i.e., the player B, and the drone is controlled so as to fly to the corresponding target position.

(Drone Risk Avoidance Operation)

There is a risk that a golf ball hit by the player A could collide with the drone 11a engaged in the assist operation to provide advice on the shooting direction, as explained earlier. Accordingly, whenever there is such a risk of collision, the drone 11a executes a risk avoidance operation so as to avoid a collision. While the drone 11a is hovering with the marker 60 let out, the server 13 transmits an image capturing command to the drone 11 so as to capture an image of the golf ball GB with the camera 113 as it is struck by the player A.

The server 13 monitors the shot golf ball GB having been struck by the player A by engaging the arithmetic operation unit 132 in captured image analysis and makes a decision as to whether or not the shot golf ball GB traveling toward the drone 11a is on a collision course with the drone 11a. Upon deciding that the shot golf ball is about to collide with the drone 11a, the server 13 transmits a flight control command to the drone 11a so as to avert the collision with the shot golf ball. In more specific terms, the drone 11a is maneuvered to a position outside the shot golf ball's trajectory by controlling the drone 11a so that it ascends or descends or moves to the left or to the right from its current position.

In addition, a collision of the shot golf ball with the drone 11a described above may occur during the assist operation executed to indicate the shot golf ball landing position described earlier or during another assist operation, as will be explained in detail later, as well as during the assist operation executed to provide advice on the shooting direction. Accordingly, during other assist operations, too, images of the environment surrounding the drone should be captured as necessary with the camera, and if a collision with the shot golf ball is predicted based on a captured image, the drone 11a should be moved for risk avoidance to a position outside the shot golf ball's trajectory, as in the case described above.

In addition, a shot golf ball hit by a player in another party may come into the play area to collide with the drone 11a. To prevent this, the server 13 may predict a possible collision of the drone 11a and the shot golf ball based on images captured with the camera 113 mounted on the drone 11a or based on images captured with the camera 113 mounted on a drone serving the other party. Since information on the images captured with the camera mounted on the drone 11 serving the other party is also received and analyzed at the server 13, the server 13 is able to make a decision as to whether or not there is a risk of a shot golf ball hitting the drone 11a by executing an arithmetic operation to determine the trajectory of the shot golf ball hit by a player in the other party based on these images.

(2-2 Advice on the Optimal Golf Club to be Used)

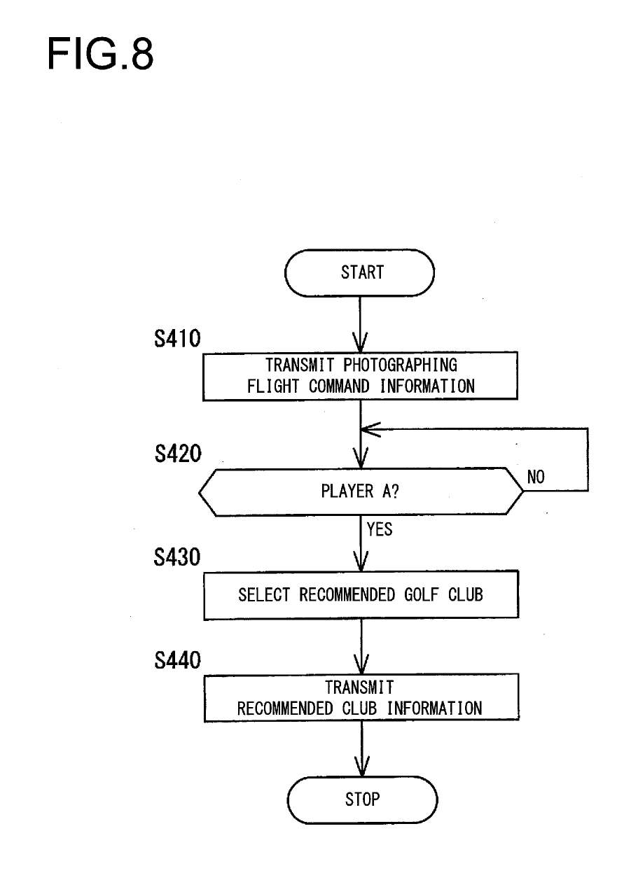

In reference to the flowchart presented in FIG. 8, an assist operation executed to provide advice on the optimal golf club to be used will be described. In step S410, the control unit 134 transmits photographing flight command information so as to allow the drone 11a to hover at a position at which an image of the entire body of the player A can be captured with the camera. In step S420, the control unit 134 engages the arithmetic operation unit 132 in face recognition based on the image captured via the camera 113 and makes a decision as to whether or not the person in the captured image is the player A.

In step S430, the control unit 134 selects a golf club deems optimal among the plurality of golf clubs registered in the player data 133b as a recommended golf club by referencing the course data 133a and the player data 133b in the database 133.

For instance, a male the player A may be registered as an advanced player. In such a case, an optimal golf club among the plurality of golf clubs is selected by comparing the recommended club for the advanced male player indicated in the course data 133a with the plurality of golf clubs registered in the player data 133b.

In step S440, the control unit 134 transmits information indicating the golf club selected in step S430 to the portable terminal 12a as recommended club information. At the portable terminal 12a having received the recommended club information, the name of the club or the like is displayed on the display unit 121.

It is to be noted that the conditions of the player A on the particular day may be judged based on previously recorded scores for the player and a golf club may be recommended based on the player conditions. For instance, the player may be struggling and may not be achieving his usual carry distance. Under such circumstances, a golf club that will achieve a greater carry distance than the golf club selected based on the course data 133a and the player data 133b should be selected as the recommended club.

In addition, if a player level is not registered for the player A in the player data 133b, the control unit 134 in the server 13 may judge the level of the player A through the following processing to recommend a golf club based on the level thus determined. First, the control unit 134 controls the position of the drone 11a so as to capture an image of the entire body of the player A with the camera 113. The control unit 134 controls the position of the drone 11a, the angle of view of the camera 113 and the photographing direction based on images transmitted from the drone 11a so as to obtain an image that enables swing analysis.

Once an image capturing preparatory operation at the drone 11a is completed, the control unit 134 engages the portable terminal 12a in operation so that it issues a message (a visual message or an audio message) prompting the player A to take a full practice swing and obtains an image of the player A swinging the club. The player does not actually hit the golf ball. The control unit 134 executes image analysis for the swing in the image thus obtained and makes a decision as to the level of the player A, advanced, intermediate or beginner. The decision-making results are registered in the player data 133b in the database 133.

(2-3 Advice on Shot-Making)

Through this assist operation, instructions on the optimal stance, the optimal grip and the like are provided to the player A before his shot. The control unit 134 in the server 13 captures an image of the golf ball GB on the course with the camera 113 mounted on the drone 11a and estimates the course conditions based on the captured image. For instance, it may detect the inclination of the ground where the golf ball GB lies based on the image, and the server 13 may provide advice for the player A related to the optimal stance, the optimal grip and the like based on the ground inclination, the direction of the green, the distance to the green, the level of the player A and the like. The details of the advice are displayed at the display unit 121 at the portable terminal 12a. Information indicating degrees of incline of the ground, details of advice to be provided when a shot is to be made on an uphill slope, details of advice to be provided when a shot is to be made on a downhill slope and the like are stored in advance in the course data 133a in the database 133.

The player provided with advice during the game as described above is able to play under more optimized conditions (with respect to the golf clubs, form and the like) so as to improve his performance.

### Third Embodiment

The assist operation executed in the third embodiment provides greater the player convenience. More specifically, through this operation, the drone 11 may be controlled to retrieve a shot golf ball that has flown outside the course, a report indicating that the shot golf ball has landed in a pond within the course may be issued or an extra golf ball may be delivered to the player if the golf ball in the shot is in the water and cannot be retrieved, or the like.

(3-1. Assist Operation for Retrieving an OB Golf Ball)

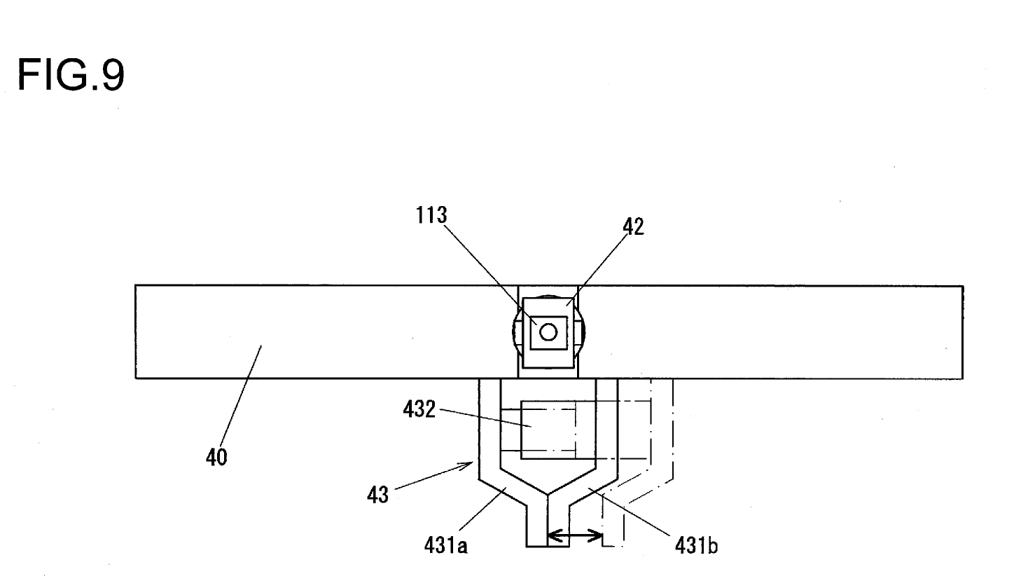

A gripping device 43 such as that shown in FIG. 9 is mounted on the drone 11. The gripping device 43 includes a pair of gripper plates 431a and 431b that open and close and an actuator 432 that drives the gripper plate 43 lb so as to switch between an open and closed position.

The assist operation for retrieving a shot golf ball is executed after the assist operation described in reference to the first embodiment through which the shot golf ball landing position is indicated. Namely, during the assist operation for reporting the landing position, the server 13 is able to determine whether or not the shot landing position is out of bounds based on the GPS position information provided from the drone 11 and the course data 133a in the database 133. If the shot golf ball is determined to have landed out of bounds, the assist operation for retrieving the shot golf ball is executed.

The server 13 compares the golf ball landing position with the course data 133a in the database 133, and if the shot golf ball position is out of bounds, it transmits a control command (a flight command and a grip command) so as to engage the drone 11 in operation to retrieve the golf ball. In response to the flight command issued by the server 13, the drone 11 descends from the position at which it has been hovering above the landing position and retrieves the golf ball with the gripping device 43. The drone 11 then delivers the retrieved golf ball to the player or to the cart 220.

When a golf ball lands out of bounds and an image of an estimated golf ball landing position is captured from above, the golf ball may not be recognized in the image. For instance, the golf ball may be hidden in the rough or behind a tree branch. Under such circumstances, the server controls the camera so that it zooms in and detects the golf ball in the zoomed-in image.

(3-2 Assist Operation Executed when a Shot Golf Ball Cannot be Retrieved)

If the golf ball struck by a player falls into a pond, the server 13 is able to determine that the golf ball has fallen into a pond by recognizing a splash of water or the like in the image. A decision as to whether or not the golf ball has fallen into a pond may be made in the image as described above or by checking the GPS position information provided from the drone 11 hovering above the landing position and the course data 133a. However, the golf ball in the water cannot be detected in an image and the drone 11 cannot retrieve the golf ball.

Accordingly, if a golf ball has fallen into a pond, the player and the like are notified that the golf ball cannot be retrieved. For instance, a text message indicating that the golf ball cannot be retrieved at the display unit 121 at the portable terminal 12 or notification information may be displayed on the display device 221 in the cart 220.

In addition to a golf ball falling into a pond, a golf ball that has gone into the woods and become lost and a golf ball that has gone out of bounds where the drone 11 cannot follow, cannot be retrieved. In these cases, too, a notification indicating that the golf ball cannot be retrieved, similar to that issued when the golf ball has fallen into a pond, is issued. The server 13 judges that the drone 11 cannot fly to the landing position based on an image captured with the camera 113.

Upon reporting that the golf ball cannot be retrieved, as described above, the drone 11 may supply the player with an extra golf ball. In this case, the drone 11 with extra golf balls loaded therein in advance may fly to the spot where the player is and drop a golf ball near the player. As an alternative, the drone 11 may fly over to the cart 220 to pick up a golf ball and deliver it to the player.

In another example of an assist operation that may be executed in the third embodiment, the drone 11 is engaged in operation to lift up the flag from the hole before a shot is made on the green. In this case, the server controls the gripping device 43 mounted on the drone 11 to grip the flag pole and moves the drone 11 up while the flag pole is gripped. In addition, the drone 11 may be engaged in a sand-fill operation to pour sand into a divot made by a club swing. Upon ascertaining, based on an image captured with the camera 113, that a divot has been created, the server 13 outputs a command for the drone 11 so as to fill sand into the divot. It is to be noted that instead of filling sand, an assist operation for informing maintenance personnel of the location of the divot may be executed. In response, maintenance personnel are able to travel to the location of the divot to repair it. In addition, the drone 11 may be engaged in a bunker-grooming operation after a bunker shot.

In the third embodiment described above, the drone 11, in place of a caddie, is tasked to perform various types of bothersome operations that may become necessary during golf play, making it possible for the player to focus on his game. In addition, the game can be played smoothly with a minimum of interruptions.

### Fourth Embodiment

Through the assist operation executed in the fourth embodiment, the player is notified of potential danger. Examples of such assist operations include an operation executed to report the presence of another party in the vicinity, and an operation for reporting the presence of a dangerous object.

(4-1. Reporting Another Party in the Vicinity)

An assist operation such as that described below may be executed when, for instance, the game played by the preceding party (hereafter referred to as a party PA) is playing slow and thus the party PA and a succeeding party (hereafter referred to as a party PB) end up on the same hole.

The server 13 sends off a drone 11 assigned to the party PB on an exploratory flight to the green during the game played by the party PB so as to ascertain whether or not another party is in the vicinity. This mission may be executed by, for instance, controlling the drone 11 so that it flies to the middle point between the party PB and the green and increasing the altitude of the drone 11 to a position at which both the green and the party PB are captured in an image.

If a player belonging to the preceding party PA is detected in the captured image, the server 13 estimates, based on the image, the distance between the party PA and the party PB. If the server 13 judges, based on the estimated distance, that the party PB is too close to the preceding party PA, it transmits warning information to the portable terminal 12 carried by a player in the party PB or to the display device 221 in the cart 220 disallowing any shots. Once the warning information has been received at the portable terminal 12 or at the display device 221 in the cart 220, a warning message disallowing any shot is displayed on the corresponding display unit. As an alternative, a warning message may be provided in the form of a warning sound or an audio message. As a further alternative, the drone 11 may stop flying to signal to each the player that play cannot continue.

In addition, the server 13 may also transmit information to the portable terminal 12 carried by a player in the preceding party PA indicating that the succeeding party PB is catching up. For instance, a message prompting the player to speed up his play may be transmitted to the portable terminal 12. In this situation, the server 13 may issue an instruction for the cart 220 to increase speed.

It is to be noted that the presence of the preceding party PA in the vicinity is reported based on an image captured with the camera 113 mounted on the drone 11 serving the succeeding party PB in the explanation provided above. As an alternative, an image of the party PA and the succeeding party PB may be captured with the camera 113 mounted on a drone 11 serving the party PA so as to ascertain, based on the image thus captured, the proximity to the succeeding party PB.

In addition, instead of judging the distance to another party based on an image captured by the camera 113 mounted on a drone, the server 13 may judge the distance between the party PB and the party PA based on the GPS position information provided by a drone 11 serving the party PB and the GPS position information provided by a drone 11 serving the other party PA. Furthermore, a GPS receiver may be installed in each cart 220 and in such a case, the distance between carts 220 may be judged to be the distance between one party and the other party.

(4-2. Reporting an Errant Ball)

An assist operation executed to report to players that a golf ball struck by a player on another hole is flying into their area will be explained next. The server 13 estimates the direction and carry distance of a shot golf ball based on an image captured when the shot is made and makes a decision as to whether or not the shot golf ball will fly into the area of another hole. Upon deciding that the shot golf ball will fly into the area of another hole, the server 13 transmits errant ball information reporting that a golf ball is flying into the area of the other hole to the portable terminal 12 carried by a player playing the other hole. The portable terminal 12, having received the errant ball information notifies the player of the approaching golf ball by displaying a warning on the display unit 121 or by outputting a warning sound. In addition, the errant ball information may be displayed on the display device 221 in the cart 220. The assist operation for reporting an errant ball is executed while another assist operation is underway.

(4-3. Reporting Dangerous Areas)

Data related to dangerous areas where snakes, wasps and the like are often present are included in the course data 133a in the database 133. If a player moves closer to such a dangerous area, the server 13 transmits warning information to the portable terminal 12 carried by the player alerting the player that he is close to a dangerous area. For instance, if the shot golf ball landing position is close to a dangerous area, the server 13 brings up a snake warning display or a wasp warning display together with the landing position display at the portable terminal 12. As an alternative, a warning sound may be generated at the portable terminal 12.

In addition, if the shot golf ball landing position is not out of bounds, the server 13 may use the camera 113 mounted on a drone 11 to capture zoomed-in images of the landing spot and the surrounding area so as to detect any snakes, wasps or the like in the captured images. This assist operation may be executed only when a shot golf ball has landed at a point close to one of preregistered dangerous areas or may be executed irrespective of whether or not the landing point is close to a dangerous area.

In the fourth embodiment described above, a potentially dangerous situation that may occur during a golf game can be preempted by generating a warning via the drone 11. Consequently, players are able to play the game safely.

### Fifth Embodiment

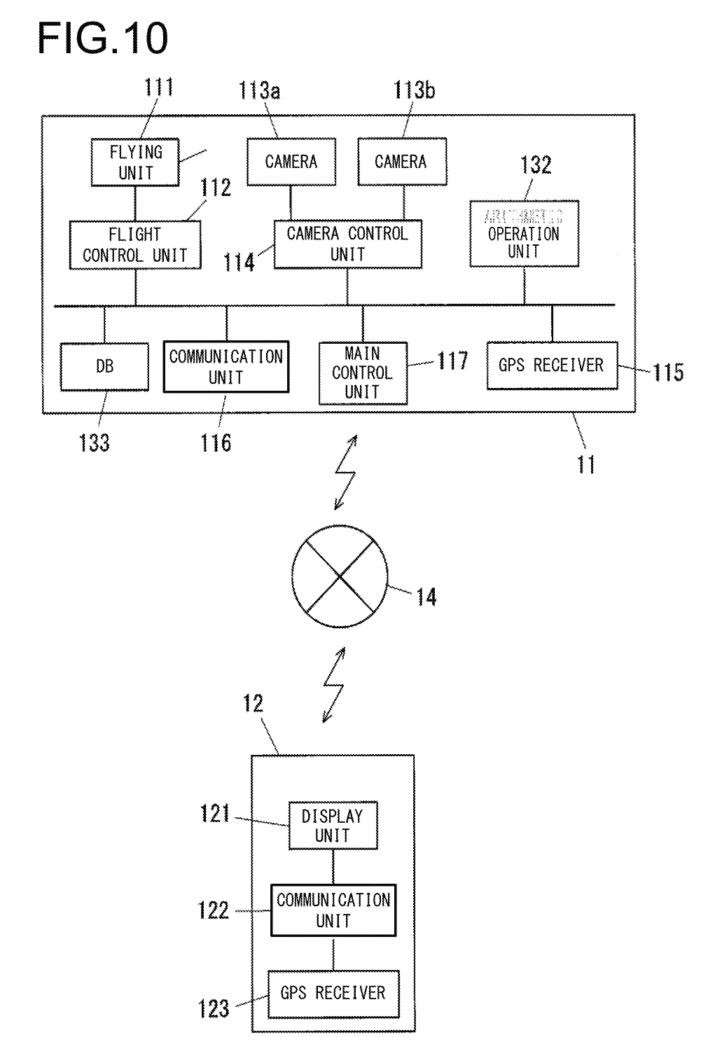

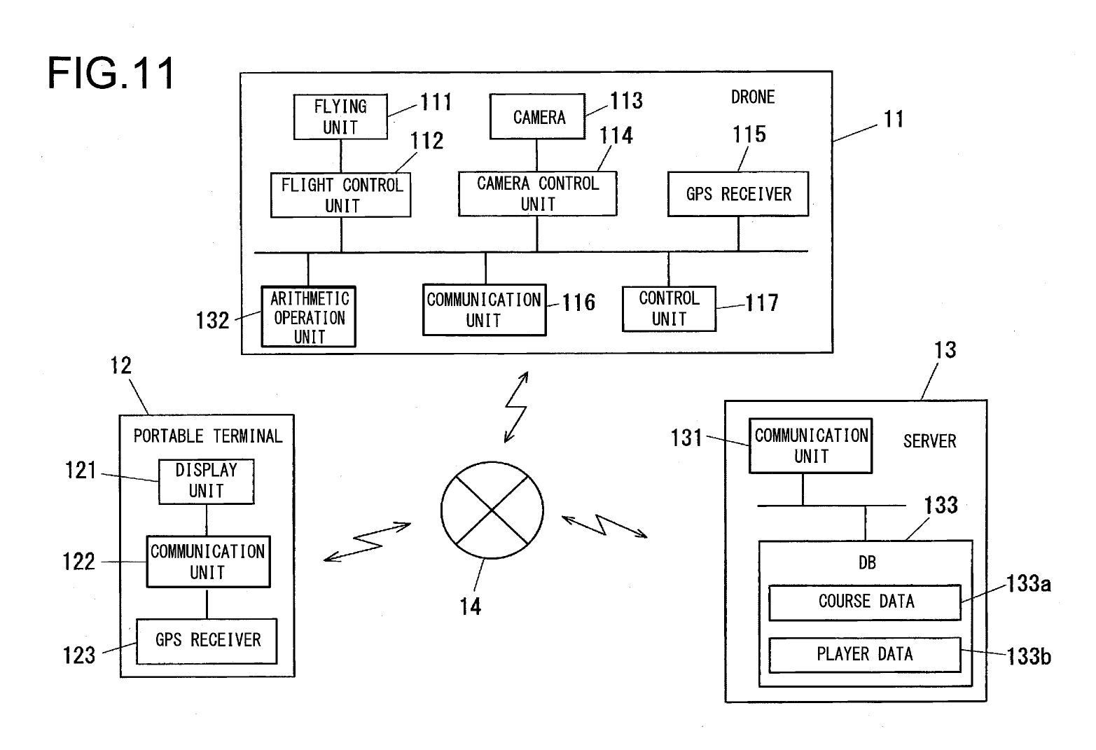

While golf assistance is provided through coordinated operation executed by a drone 11 and the server 13 jointly in the configuration achieved in the first through fourth embodiments described above, the functions carried out by the server 13 may instead be fulfilled in a drone 11, as shown in FIG. 10. As an alternative, the functions of the control unit 134 and the arithmetic operation unit 132 in the server 13 may be built into a drone 11 so as to allow the server 13 to fulfill database functions alone, as shown in FIG. 11. In either case, the assist operation processing described earlier (the processing executed by the control unit 134 in the server 13) is instead executed by the control unit 117 in the drone 11.

In addition, while data exchange between the drone 11 and the portable terminal 12 is carried out via the communication network 14 in the example presented in FIG. 10, data may be exchanged directly by the drone 11 and the portable terminal 12, instead.

In addition, it is not strictly necessary for the drone 11 to be equipped with a camera 113. Images may instead be captured with fixed cameras installed around the golf course. In this configuration communication among the fixed cameras, the drone 11 and the server 13 is enabled so that image data expressing images captured by the fixed cameras can be transmitted and received. The drone 11 or the server 13 receives image data expressing images captured by the fixed cameras and is able to execute the processing described in reference to the embodiments by using the image data.

It is to be noted that while the position to be assumed by the drone 11 when capturing an image of the player or capturing an image of a shot being made with the camera 113 mounted on the drone 11 is determined based on GPS position information and image information in the embodiments described above, the player may instead issue an instruction via the portable terminal 12 and the server 13 may transmit flight command information in response to the instruction.

While the sport assist operations are executed to provide assistance golfers in the examples described in reference to the embodiments, the present invention may be adopted to provide assistance to players of flying disk games (such as disk golf). In such a case, too, players playing a flying disk game are able to play the game smoothly. It is to be noted that a flying disk is also referred to as a Frisbee (registered trademark).

It is to be noted that a program enabling the processing described in reference to the flowchart presented in FIG. 3, 7 or 8 is executed by the control unit 134 in the server 13 or by the control unit 117 in the drone 11. The control units 117 and 134 are each constituted with a CPU, a recording medium (a ROM, a memory card, a hard disk or the like) and peripheral circuits, and the program, which is stored in the recording medium, is executed by the CPU.

For instance, the program, which may be a program enabling control of the flying unit 111 of a drone 11 that flies with a camera 113, to function as an image capturing unit, installed therein, that enables the control unit 117 or the control unit 134 to execute image capturing processing through which the camera 113 is engaged in image capturing operation to capture an image of a moving object embodied as a golf ball GB, and control processing through which at least either the flying unit 111 or the camera 113 is controlled with control information generated based on an output from the camera 113 so as to engage the camera 113, having captured the image of the golf ball GB, in operation to capture an image of the golf ball GB. In addition, the program may be a program enabling control of the flying unit 111 capable of flying, that enables the control unit 117 or the control unit 134 to execute acquiring process through which flight information based on information related to a sporting game such as golf, is obtained, and control processing through which the flying unit 111 is controlled based on the flight information.

While the embodiments have been described in reference to an example in which the present invention is adopted in a flying device such as an unmanned aerial vehicle 11, the present invention is not limited applications in a flying device and may be adopted in a moving device equipped with a moving unit such as wheels or a bipedal mechanism instead of the flying unit 111. As in applications that include the flying unit 111, an image capturing unit (e.g., a camera 113) capable of capturing an image of a moving object should be installed at the moving unit. In this case, too, control similar to that executed in conjunction with the flying device is executed, although the moving device includes the moving unit instead of the flying unit 111. For instance, after an image of the object is captured via the image capturing unit, the control unit 134 will control at least either the moving unit or the image capturing unit with control information generated based on an output from the image capturing unit so as to capture an image of the object via the image capturing unit. As an alternative, the control unit 134 or a control unit disposed at the moving unit may be engaged in execution of acquiring process through which movement information based on information related to a sporting game such as golf is obtained and control processing through which the moving unit is controlled based on the movement information.

Furthermore, the moving device does not need to include an image capturing unit (e.g., a camera 113). Images may instead be captured with fixed cameras installed around the golf course. In this configuration, communication among the fixed cameras, the moving device and the server 13 are enabled so that image data expressing images captured by the fixed cameras can be transmitted and received. The moving device or the server 13, having received image data expressing images captured by the fixed cameras, is able to execute the processing described in reference to the embodiments by using the image data.

While various embodiments and variations thereof have been described above, the embodiments and variations may be adopted in combination.

The present invention is in no way limited to the particulars of the embodiments and variations described above and any mode conceivable within the scope of the technical teaching of the present invention is also within the scope of the invention.

The disclosure of the following priority application is herein incorporated by reference:

Japanese Patent Application No. 2015-195278 filed Sep. 30, 2015

### REFERENCE SIGNS LIST

1 . . . assistance system, 11, 11a, 11b . . . unmanned aerial vehicle (drone), 12, 12a, 12b . . . portable terminal, 13 . . . server, 14 . . . communication network, 43 . . . gripping device, 60 . . . marker, 70 . . . landing position, P1, P11 . . . predetermined position, P2, P4 . . . flight target position, 111 . . . flying unit, 112 . . . flight control unit, 113 . . . camera, 114 . . . camera control unit, 115, 123 . . . GPS receiver, 116, 122, 131 . . . communication unit, 117, 134 . . . control unit, 132 . . . arithmetic operation unit, 133 . . . database, 220 . . . cart

1-50. (canceled)

51. A flying device, comprising:
an acquiring unit that obtains information related to a sporting game;
a flying unit that flies with the acquiring unit; and
a control unit that controls the flying unit based on the information related to the sporting game.

52. The flying device according to claim 51, wherein:
the acquiring unit obtains image data of the sporting game; and
the control unit controls the flying unit based upon the image data.

53. The flying device according to claim 52, wherein:
the acquiring unit obtains the image data of a ball used in the sporting game; and
the control unit controls the flying unit to track the ball based on the image data.

54. The flying device according to claim 53, wherein:
the acquiring unit obtains information related to a position at which the ball landed; and further comprising:
a communication unit that transmits information related to the position to another device.

55. The flying device according to claim 53, wherein:
the acquiring unit obtains information related to a position at which the ball landed; and
the control unit controls the flying unit so that the flying unit flies above the position at which the ball landed.

56. The flying device according to claim 52, wherein:
the control unit controls the flying unit so that the flying unit flies to a visible position at which the flying unit can be seen by a player of the sporting game.

57. The flying device according to claim 52, wherein:
the acquiring unit obtains information related to a ball used in the sporting game; and
the control unit controls the flying unit so that the flying unit flies to a position at which the flying unit does not collide with the ball.

58. The flying device according to claim 51, wherein:
the acquiring unit obtains image data with varying angles of view.

59. The flying device according to claim 51, wherein:
the acquiring unit obtains information related to a sun position; and
the control unit controls the flying unit based on the information related to the sun position.

60. The flying device according to claim 51, wherein:
the sporting game is golf.

61. A program for controlling a flying device, that enables a computer to execute:
acquiring processing through which information related to a sporting game is obtained; and
control processing through which control information to control the flying device is generated based on the information related to the sporting game.

62. An electronic device, comprising:
an acquiring unit that obtains information related to a sporting game;
a communication unit that communicates with a moving device; and
a control unit that controls to transmit control information based on the information related to the sporting game, to the moving device via the communication unit.

63. A moving device, comprising:
an acquiring unit that obtains information related to a sporting game;
a driving unit that moves with the acquiring unit; and
a control unit that controls the driving unit based on the information related to the sporting game.
